(19) United States
(12) Patent Application Publication
(10) Pub. No.: US 2010/0011635 A1
(43) Pub. Date: Jan. 21, 2010

(54) Die-Cutting Method for Improving Tear Resistance on a Film Laminated Paperboard Card

(75) Inventors: Larry L. Sipe, Clayton, NC (US); Michael P. Wade, Chesterfield, VA (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEADWESTVACO CORPORATION, Glen Allen, VA (US)

(21) Appl. No.: 12/497,155

(22) Filed: Jul. 2, 2009

Related U.S. Application Data
(60) Provisional application No. 61/081,404, filed on Jul. 17, 2008.

(51) Int. Cl. G09F 1/00; B31F 7/00; B65D 73/00; B65D 65/28

(52) U.S. Cl. 40/124.06; 493/340; 206/461; 428/43

(57) ABSTRACT

A security package is disclosed having a barrier cut to stop tears from propagating into the package.

### REFERENCE TO RELATED APPLICATION

This application claims the benefit of priority under 35 U.S.C. §119(e) of provisional application Ser. No. 61/081,404 filed on Jul. 17, 2008, which is hereby incorporated by reference in its entirety.

### BACKGROUND

The present application is directed to paperboard security packages and, more particularly, to improving the tear resistance of paperboard security packages.

Manufacturers and retailers of consumer goods, such as pharmaceuticals, software, electronics, health and beauty products and the like, typically package their products in tamper resistant security packages. For example, many consumer goods are packaged in blister packages formed by positioning a consumer good in a flanged blister made from various polymeric and/or paperboard materials and sealing the flanged blister between two paperboard substrates.

As an initial step in creating such packages, a paperboard substrate may be provided with a coating or layer of tear resistant material. Often this substrate may be in a continuous web form, easily processed by automated equipment. The tear resistant material may be die-cut into a blank or blanks of the desired size and shape. For each blank or set of blanks, the die-cutting process may cut a hole or opening to receive the blister, and may cut the periphery of the blank, which usually defines the outer periphery of the eventual package. In such a continuous web process, or even if the blanks are created by a sheet-fed process instead of a web-fed process, it is often desirable after die-cutting to keep the blank and the surrounding waste substrate together until a later step in the process. Instead of the cutting die completely penetrating through the substrate to form a hole, opening, or periphery of the blank, the cutting die may, at a few points along the cut line, leave portions of the line uncut or only cut partway through the substrate. Such uncut portions are typically short sections commonly known as “nicks.” The cutting die may during use become somewhat dulled through wear and tear, and through contact with support surfaces under the blank. Such surfaces may be metal and if cutting clearances are not exact, deformation may occur to the cutting edge of the die. The die may thus develop microscopic defects that cause cut imperfections in the die-cut lines.

Later in the formation of a blister card, the blank is separated from the web or from other surrounding “waste” substrate. The remnants of each nick are usually small enough so as to be not very noticeable. Cut imperfections caused by die defects may not be visible.

For security packaging, where tear-resistance is desired, a nick or a cut imperfection may create an undesirable tear initiation point. Accordingly, there is a need for a die-cutting process that less prone to tearing, including tearing initiated at such points.

### SUMMARY

In one aspect, a display card is disclosed comprising a front layer and a back layer, with at least a portion of said layers adhered together, a product-receiving volume, disposed within or upon said display card, and a barrier cut in at least one of said front and back layers.

In another aspect, a display card is disclosed comprising a substrate layer bounded by a perimeter, and a barrier cut proximate to said perimeter and spaced apart from said perimeter, and extending at least partially along said perimeter.

In another aspect, a method is disclosed for forming a blank for a display card, comprising providing a substrate in web or sheet form, cutting from said substrate said blank for said display card, said blank having a cut perimeter, and providing a barrier cut proximate to said perimeter and spaced apart from said perimeter, and extending at least partially along said perimeter.

In another aspect, a blank or package is made using the process.

Other aspects of the disclosed method and products created thereby will become apparent from the following description and the accompanying drawings.

### BRIEF DESCRIPTION OF THE DRAWINGS

FIGS. 1A and 1B are views of prior art die-cut blanks for a package;

FIGS. 2A and 2B are views of other prior art die-cut blanks for a package;

FIGS. 3A and 3B are views of die-cut blanks with a barrier cut; and

FIGS. 4A and 4B are views of other die-cut blanks with a barrier cut.

### DETAILED DESCRIPTION

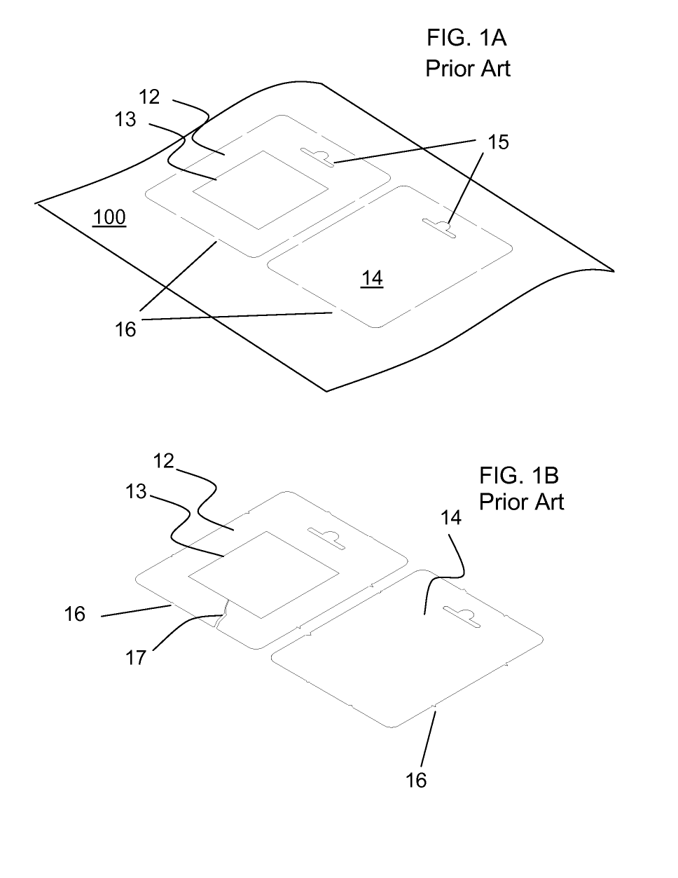

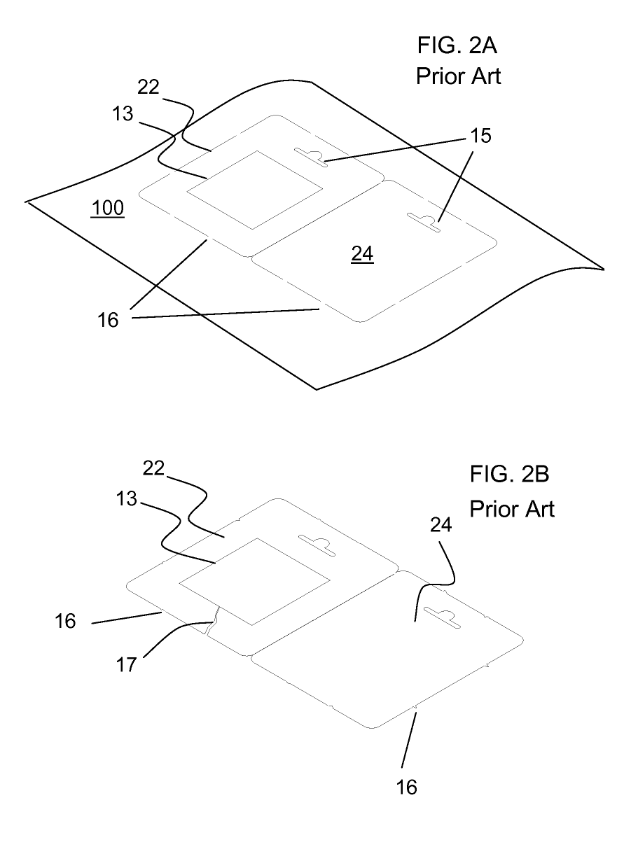

Paperboard security packages, such as blister packages, are well known by those skilled in the art. Such packages are often formed from paperboard blanks. Conventional prior art blanks are illustrated in FIGS. 1A, 1B, 2A, and 2B. For example FIG. 1A shows a die-cut front blank 12 and back blank 14. The front blank 12 comprises an opening 13 that may receive a blister. The opening may have any shape or size to fit a blister suitable for receiving whatever contents are to be enclosed in the blister. The blister may comprise a plastic material such as a transparent polymer, or another sheet material such as a paperboard molded, folded, or otherwise formed shell. The blanks may comprise a hanging aperture 15. Typically the blanks would be die-cut from substrate 100 in sheet or web form. Nicks 16 may be provided to hold the blanks in the substrate during handling. Worn cutting edges may also cause unintended imperfections in the edge of the blanks.

FIG. 1B shows front blank 12 and back blank 14 removed from substrate 100. Typically, a blister (not shown) may now be placed in opening 13 and the front blank 12 then sealed to the back blank 14. Opening 13 may be any shape or size to accommodate a suitable blister. In order to secure the blister, a flange may extend around the bottom of the blister such that when the blister is inserted through the opening 13, the flange is captured between the front blank 12 and back blank 14 to prevent the blister from being pulled through opening 13. The front blank 12 and back blank 14 may be sealed using a sealing technique such as heat sealing, radio frequency sealing, ultrasonic sealing, microwave sealing and/or adhesives. To provide for sealing, one or both blanks may have a layer of heat sealable material applied by coating or other methods. A suitable material is NATRALOCK® paperboard made by MeadWestvaco Corporation.

Nicks 16 upon separation from substrate 100 may take the form of small torn areas. These may provide an initiation point for a tear 17 that may compromise the package. Even if a tear-resistant coating is provided on one of the blanks, nick 16 may afford enough of a tear-initiation point to overcome the tear resistance. Also, the hanging aperture 15 may provide a tear-initiation point.

Referring now to FIG. 2A, a die-cut front blank 22 and back blank 24 are shown which, instead of being formed separately, are formed as a unitary part die-cut from web 100. The front blank 22 comprises an opening 13 that may receive a blister. The blanks may comprise a hanging aperture 15. Nicks 16 may be provided to hold the blanks in the substrate during handling. Again, worn cutting edges may also cause unintended imperfections in the edge of the blanks.

FIG. 2B shows the unitary front blank 22 and back blank 24 removed from substrate 100. Typically, a blister (not shown) may now be placed in opening 13 and the front blank 22 then folded onto and sealed to back blank 24. Opening 13 may be any shape or size to accommodate a suitable blister. In order to secure the blister, a flange may extend around the bottom of the blister such that when the blister is inserted through the opening 13, the flange is captured between the front blank 22 and back blank 24 to prevent the blister from being pulled through opening 13. The front blank 22 and back blank 24 may be sealed using a sealing technique such as heat sealing, radio frequency sealing, ultrasonic sealing, microwave sealing and/or adhesives.

Nicks 16 upon separation from substrate 100 take the form of small torn areas. These, as well as small imperfections in the cut periphery of the blanks, may provide an initiation point for a tear 17 that may compromise the package. Even if a tear-resistant coating is provided on one of the blanks, nick 16 may afford enough of a tear-initiation point to overcome the tear resistance.

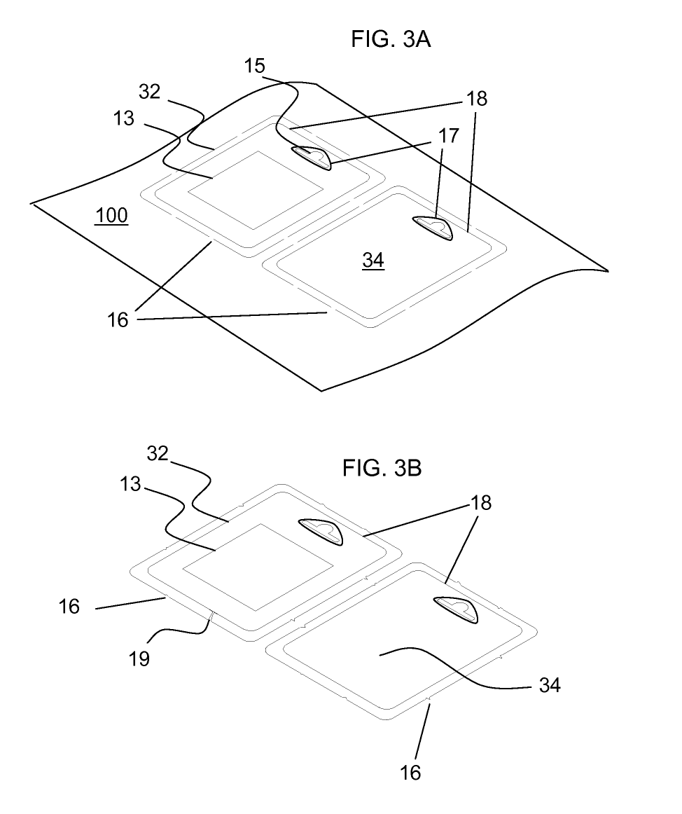

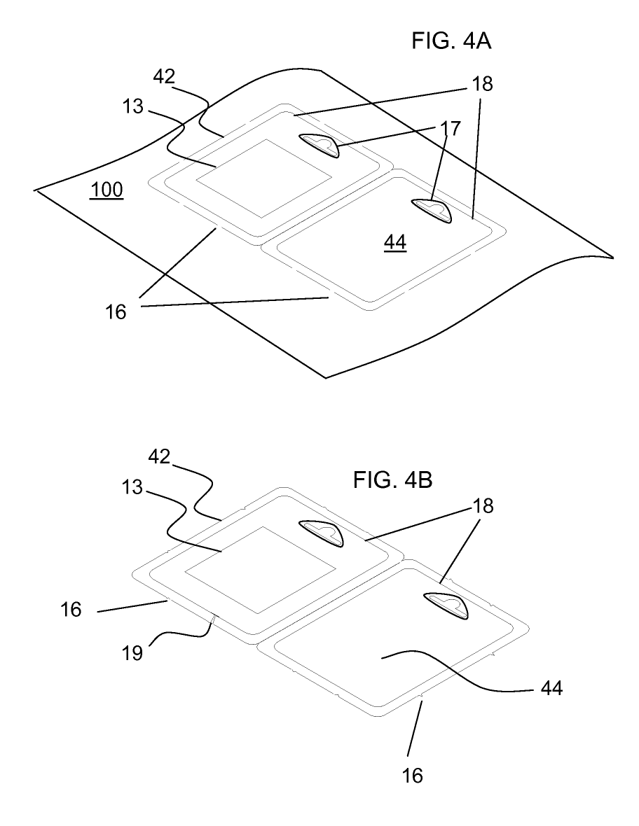

Certain embodiments of a novel package are illustrated in FIGS. 3A, 3B, 4A and 4B. For example FIG. 3A shows a die-cut front blank 32 and back blank 34. The front blank 32 comprises an opening 13 that may receive a blister. The blanks may comprise a hanging aperture 15. Typically the blanks would be die-cut from substrate 100 in sheet or web form. Nicks 16 may be provided to hold the blanks in the substrate during handling. In order to provide added resistance to tearing, a barrier cut 18 may be provided on one or both blanks. In an exemplary embodiment, at least one blank is coated or otherwise provided on at least one surface with a tear resistant material, and the barrier cut 18 is cut only partially through the blank, for example, only deep enough to cut through the tear resistant layer. The barrier cut 18 as shown is a continuous path and follows the entire outer periphery of each blank, spaced slightly inward from the outer edge. However, the barrier cut could be discontinuous, for example placed only adjacent to nicks 16, and may not always follow exactly the periphery of the blank(s). In a given location, more than one barrier cut may be provided. For example another barrier cuts may be provided inside the perimeter of barrier cut 18. Likewise, more than two barrier cuts may be provided. Features such as hanging aperture 15, that may be prone to tear initiation, may be provided with barrier cuts such as barrier cut 17. Preferably the barrier cut 17 or 18 may have a relatively smooth path. For example, if the shape of front blank 32 or back blank 34 includes a feature such as an indendation, notch, narrowed region, or other irregular contour (not shown), the barrier cut 18, instead of closely following the irregular feature, may take a smooth path around the inside of the feature.

FIG. 3B shows front blank 32 and back blank 34 removed from substrate 100. As described previously, a blister (not shown) may be placed in opening 13 and the front blank 32 then sealed to the back blank 34. Nicks 16 upon separation from substrate 100 take the form of small torn areas. These may provide an initiation point for a tear 19. However, the tear 19 instead of propagating into the center of the package will be redirected sideways upon reaching barrier cut 18, thus preventing further tearing into the package. Particularly if a tear-resistant coating is provided on one of the blanks, the barrier cut 18 may provide a block against tear-initiation point by the nicks 16 or elsewhere around the periphery of the blank(s). The barrier cut 18 may provide some tear resistance even in the absence of a specific tear-resistant material.

Barrier cut 17, likewise, may provide resistance against tears initiated at the hanging aperture. Since barrier cuts 17, 18 preferably may not penetrate entirely through the blank, the cutting tool (such as a die) likely will not be prone to wear and tear caused by contacting the support surface behind the blank. Thus, barrier cuts 17, 18 may be expected to be relatively free of imperfections, helping prevent further propagation of any tears that reach the barrier cut.

Referring now to FIG. 4A, a die-cut front blank 42 and back blank 44 are shown that, instead of being formed separately, are formed as a unitary part die-cut from web 100. The front blank 42 comprises an opening 13 that may receive a blister. The blanks may comprise a hanging aperture 15. Nicks 16 may be provided to hold the blanks in the substrate during handling.

FIG. 4B shows unitary front blank 42 and back blank 44 removed from substrate 100. As described previously, a blister (not shown) may be inserted and the front blank 42 then folded onto and sealed to back blank 44.

Nicks 16 upon separation from substrate 100 may take the form of small torn areas. These may provide an initiation point for a tear 19. However, the tear 19 instead of propagating into the center of the package will be redirected sideways upon reaching barrier cut 18, thus preventing further tearing into the package. Particularly if a tear-resistant coating is provided on one of the blanks, the barrier cut 18 may provide a block against tear-initiation point by the nicks 16 or elsewhere around the periphery of the blank(s). The barrier cut 18 may provide some tear resistance even in the absence of a specific tear-resistant material.

While the embodiments described here use die-cutting as an exemplary method to provide barrier lines in a package, it will be understood that other methods may be utilized, for example laser cutting, roller cutting, match metal tooling, shearing, knife cuts, and other methods to provide continuous barrier cuts, discontinuous barrier cuts, barrier cuts to varying depths, or any other methods that would provide a barrier or diffusion point to thwart tearing that might be initiated at a nick point, or at any peripheral point.

Those skilled in the art will appreciate that the disclosed blister packaging structures and associated barrier cuts may provide a theft deterrent function, without unduly interfering with legitimate consumers who may use a tool such as a scissors to make a cut that goes past the barrier cut 18 so as to allow tearing open the structure.

Although various aspects of the disclosed blister packaging structures have been shown and described, modifications may occur to those skilled in the art upon reading the specification.

1. A display card for holding an item, the card comprising:
a front layer and a back layer, with at least a portion of said layers adhered together,
a product-receiving volume, disposed within or upon said display card, and
a first barrier cut in at least one of said front and back layers.

2. The display card of claim 1, wherein at least one of said front and back layers comprises a tear-resistant material, film, or coating.

3. The display card of claim 1, wherein said first barrier cut penetrates only partway through said front or back layer.

4. The display card of claim 2, wherein said first barrier cut penetrates only partway through said tear-resistant material, film, or coating.

5. The display card of claim 1, wherein said first barrier cut is proximate to and spaced apart from the outer periphery of said front or back layer.

6. The display card of claim 5, wherein said first barrier cut is continuous along the entirety of said outer periphery.

7. The display card of claim 5, wherein said first barrier cut is discontinuous along portions of said outer periphery.

8. The display card of claim 5, 6, or 7, further comprising at least one additional barrier cut, wherein said first barrier cut follows a first path, and said at least one additional barrier cut follows a second path situated within said first path.

9. The display card of claim 1, wherein one of said front layer and said back layer has a perimeter with an irregular region, and said barrier cut follows a smooth path in the vicinity of said irregular region.

10. The display card of claim 1, wherein one of said front layer and said back layer comprises an opening or aperture, and a third barrier cut is provided around said opening or aperture.

11. The display card of claim 1, wherein said barrier cut is concealed between said front and back layers.

12. The display card of claim 1, wherein said product-receiving volume comprises a blister.

13. The display card of claim 12, wherein said blister is retained between said front and back layers.

14. The display card of claim 12, wherein at least one of said front and back layers contains an aperture for holding said blister.

15. The display card of claim 12, wherein said blister is retained upon the surface of one of said front and back layers.

16. The display card of claim 1, wherein said product-receiving volume comprises a volume formed by a folded material.

17. The display card of claim 1, wherein at least portions of said front and back layers are adhered together by an adhesive or a heat seal material.

18. The display card of claim 17, wherein a heat seal material is coated onto at least one of said front and back layers.

19. The display card of claim 1, wherein said front and back layers comprise paperboard.

20. A display card for holding an item, the card comprising:
a substrate layer,
a product-receiving volume, disposed upon said substrate layer, and
a barrier cut in said layer.

21. A blank for a display card, comprising:
a substrate layer bounded by a perimeter; and
a barrier cut proximate to said perimeter and spaced apart from said perimeter, and extending at least partially along said perimeter.

22. The blank of claim 21, wherein said barrier cut penetrates only partway into said substrate layer.

23. The blank of claim 21, wherein said substrate layer comprises a tear resistant coating or film, and said barrier cut penetrates through said tear resistant coating or film.

24. A method for forming a blank for a display card, comprising:
providing a substrate in web or sheet form;
cutting from said substrate said blank for said display card, said blank having a cut perimeter; and
providing a barrier cut proximate to said perimeter and spaced apart from said perimeter, and extending at least partially along said perimeter.

25. The method of claim 24, wherein said barrier cut does not completely penetrate said substrate.

26. The method of claim 24, wherein said substrate comprises a tear resistant coating or film, and said barrier cut penetrates through said tear resistant coating or film.

27. The method of claim 24, wherein said cut perimeter comprises at least one nick.
